(19) United States
(12) Patent Application Publication
(10) Pub. No.: US 2011/0194511 A1
(43) Pub. Date: Aug. 11, 2011

(54) MULTI-USER CONTROL CHANNEL ASSIGNMENT

(75) Inventors: Wanshi Chen, San Diego, CA (US); Hao Xu, San Diego, CA (US); Naga Bhushan, San Diego, CA (US); Sai Yiu Duncan Ho, San Diego, CA (US); Tingfang Ji, San Diego, CA (US)

(73) Assignee: QUALCOMM Incorporated, San Diego, CA (US)

(21) Appl. No.: 13/022,621

(22) Filed: Feb. 7, 2011

Related U.S. Application Data
(60) Provisional application No. 61/303,241, filed on Feb. 10, 2010.

(51) Int. Cl. H04W 72/04

(52) U.S. Cl. 370/329

(57) ABSTRACT

A method, an apparatus, and a computer program product for wireless communication are provided in which a resource assignment utilizing the PDCCH and/or the R-PDCCH may be addressed to a group of UEs, rather than an individual UE, by utilizing a group identifier for indicating to the group that there may be information for any UE in the group in the PDSCH. In this way, the capacity of the PDCCH, which is limited, is multiplied and a potential bottleneck at PDCCH scheduling can be relieved.

### CROSS-REFERENCE TO RELATED APPLICATION(S)

This application claims the benefit of U.S. Provisional Application Ser. No. 61/303,241, entitled “SYSTEMS, APPARATUS AND METHODS UTILIZING DOWNLINK CONTROL CHANNELS TO FACILITATE BURSTY TRAFFIC,” and filed on Feb. 10, 2010, which is expressly incorporated by reference herein in its entirety.

### BACKGROUND

1. Field

The present disclosure relates generally to communication systems, and more particularly, to the assignment of resources to user equipment in wireless communication systems.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

In some cases, wireless communication systems may have a high number of user equipment (UEs) that transmit or receive low-rate bursty traffic. Frequent scheduling of resources on shared traffic channels is typically employed to address these environments. However, this approach can disadvantageously cause a bottleneck at a downlink control channel for a number of reasons. The dynamic scheduling via the shared channels can require control channel traffic. However, the bottleneck can arise because the control channel has a limited power capacity and a limited frequency/time resource capacity, since, according to 3GPP standards, only the first three control symbols for large system bandwidths may be available to be allocated to control information. Thus, other ways to allocate resources for bursty traffic may be desired.

### SUMMARY

Some aspects of the present disclosure address the dimensional limitations of the PDCCH by moving scheduling information for individual UEs to the PDSCH. This may be accomplished by utilizing a group identifier to indicate to a group of UEs that the scheduling information is available in the PDSCH. This way, the capacity of the PDCCH may be multiplied by the group size. Further aspects may utilize a bitmap in the PDCCH to indicate further information regarding the resource allocation.

Further aspects of the disclosure address power limitations of the PDCCH by utilizing the relay downlink control channel (R-PDCCH) for the purpose of scheduling. This way, when a UE is enabled to decode the R-PDCCH, control information for scheduling UEs can be expanded to include space in a data region of a resource block.

In an aspect of the disclosure, a method of wireless communication for a base station may include generating a control message for indicating an allocation of channel resources to a plurality of access terminals on a shared channel, generating a packet, including a unique identifier for identifying a first access terminal of the plurality of access terminals, and a payload for the first access terminal, and transmitting the control message on a control channel and the packet on the shared channel. In another aspect of the disclosure, a method of wireless communication for an access terminal may include receiving a control message for indicating an allocation of channel resources to a plurality of access terminals on a shared channel, wherein at least a portion of the control message is scrambled with a group identifier for addressing the control message to a group of access terminals, the group comprising the plurality of access terminals, and decoding the control message to recover the allocation of channel resources.

In another aspect of the disclosure, an apparatus for wireless communication may include means for generating a control message for indicating an allocation of channel resources to a plurality of access terminals on a shared channel, means for generating a packet including a unique identifier for identifying a first access terminal of the plurality of access terminals, and a payload for the first access terminal, and means for transmitting the control message on a control channel and the packet on the shared channel. In yet another aspect of the disclosure, an apparatus for wireless communication may include means for receiving a control message for indicating an allocation of channel resources to a plurality of access terminals on a shared channel, wherein at least a portion of the control message is scrambled with a group identifier for addressing the control message to a group of access terminals, the group comprising the plurality of access terminals, and means for decoding the control message to recover the allocation of channel resources.

In yet another aspect of the disclosure, a computer program product may include a computer-readable medium having code for generating a control message for indicating an allocation of channel resources to a plurality of access terminals on a shared channel, code for generating a packet, including a unique identifier for identifying a first access terminal of the plurality of access terminals, and a payload for the first access terminal, and code for transmitting the control message on a control channel and the packet on the shared channel. In still another aspect of the disclosure, a computer program product may include a computer-readable medium having code for receiving a control message for indicating an allocation of channel resources to a plurality of access terminals on a shared channel, wherein at least a portion of the control message is scrambled with a group identifier for addressing the control message to a group of access terminals, the group comprising the plurality of access terminals, and code for decoding the control message to recover the allocation of channel resources.

In still another aspect of the disclosure, an apparatus for wireless communication may include a processing system configured to generate a control message for indicating an allocation of channel resources to a plurality of access terminals on a shared channel, to generate a packet having a unique identifier for identifying a first access terminal of the plurality of access terminals, and a payload for the first access terminal, and to transmit the control message on a control channel and the packet on the shared channel. In another aspect of the disclosure, an apparatus for wireless communication may include a processing system configured to receive a control message for indicating an allocation of channel resources to a plurality of access terminals on a shared channel, wherein at least a portion of the control message is scrambled with a group identifier for addressing the control message to a group of access terminals, the group comprising the plurality of access terminals, and to decode the control message to recover the allocation of channel resources.

### BRIEF DESCRIPTION OF THE DRAWINGS

FIG. 1 is a diagram illustrating an example of a hardware implementation for an apparatus employing a processing system.

FIG. 2 is a diagram illustrating an example of a network architecture.

FIG. 3 is a diagram illustrating an example of an access network.

FIG. 4 is a diagram illustrating an example of a frame structure for use in an access network.

FIG. 5 shows an exemplary format for the UL in LTE.

FIG. 6 is a diagram illustrating an example of a radio protocol architecture for the user and control plane.

FIG. 7 is a diagram illustrating an example of an evolved Node B and user equipment in an access network.

FIG. 8 is a flow chart of a method of allocating channel resources to one or more UEs.

FIGS. 9A and 9B illustrate exemplary MAC packets provided on a shared traffic channel.

FIG. 10 illustrates a bitmap provided on a control channel.

FIG. 11 is a flow chart of a method of allocating channel resources to one or more UEs utilizing the bitmap.

FIG. 12 is a flow chart of a method of receiving an allocation of channel resources utilizing the bitmap.

FIG. 13 is a flow chart of a method of allocating channel resources utilizing a nested assignment structure.

FIG. 14 is a diagram illustrating a frame including the R-PDCCH.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

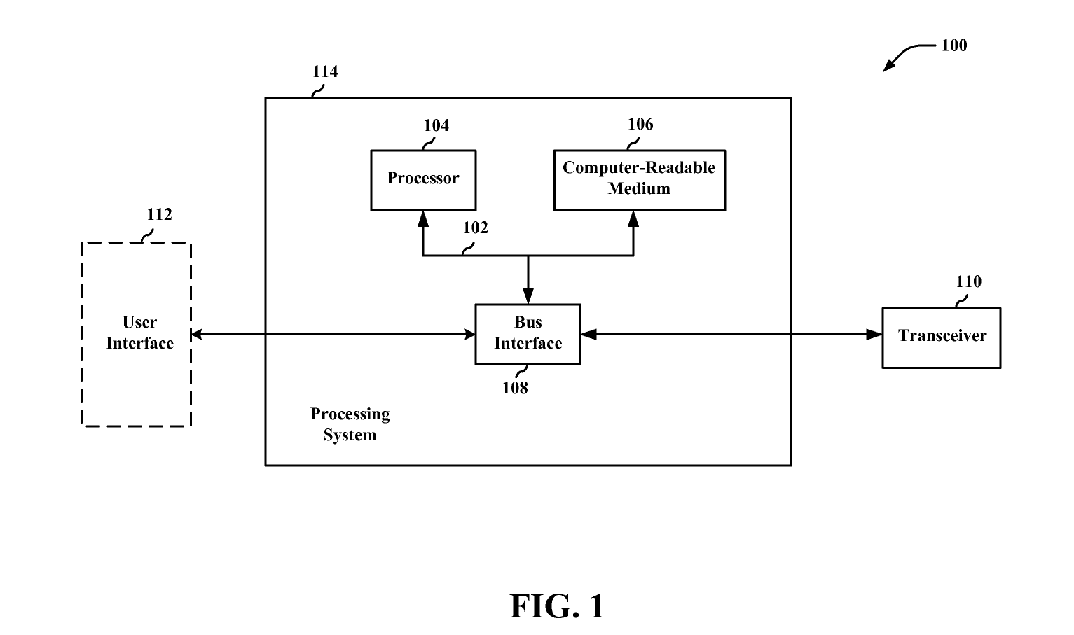

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

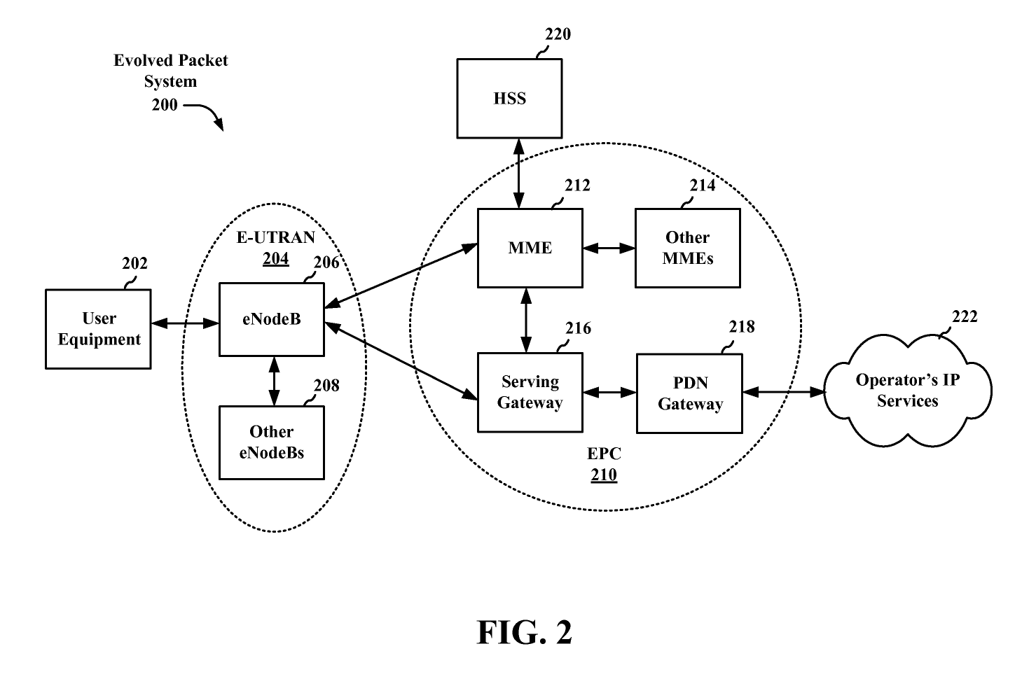

FIG. 2 is a diagram illustrating an LTE network architecture 200 employing various apparatuses 100 (See FIG. 1). The LTE network architecture 200 may be referred to as an Evolved Packet System (EPS) 200. The EPS 200 may include one or more user equipment (UE) 202, an Evolved UMTS Terrestrial Radio Access Network (E-UTRAN) 204, an Evolved Packet Core (EPC) 210, a Home Subscriber Server (HSS) 220, and an Operator's IP Services 222. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 206 and other eNBs 208. The eNB 206 provides user and control plane protocol terminations toward the UE 202. The eNB 206 may be connected to the other eNBs 208 via an X2 interface (i.e., backhaul). The eNB 206 may also be referred to by those skilled in the art as a base station, a base transceiver station, a radio base station, a radio transceiver, a transceiver function, a basic service set (BSS), an extended service set (ESS), or some other suitable terminology. The eNB 206 provides an access point to the EPC 210 for a UE 202. Examples of UEs 202 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 202 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 206 is connected by an Si interface to the EPC 210. The EPC 210 includes a Mobility Management Entity (MME) 212, other MMEs 214, a Serving Gateway 216, and a Packet Data Network (PDN) Gateway 218. The MME 212 is the control node that processes the signaling between the UE 202 and the EPC 210. Generally, the MME 212 provides bearer and connection management. All user IP packets are transferred through the Serving Gateway 216, which itself is connected to the PDN Gateway 218. The PDN Gateway 218 provides UE IP address allocation as well as other functions. The PDN Gateway 218 is connected to the Operator's IP Services 222. The Operator's IP Services 222 include the Internet, the Intranet, an IP Multimedia Subsystem (IMS), and a PS Streaming Service (PSS).

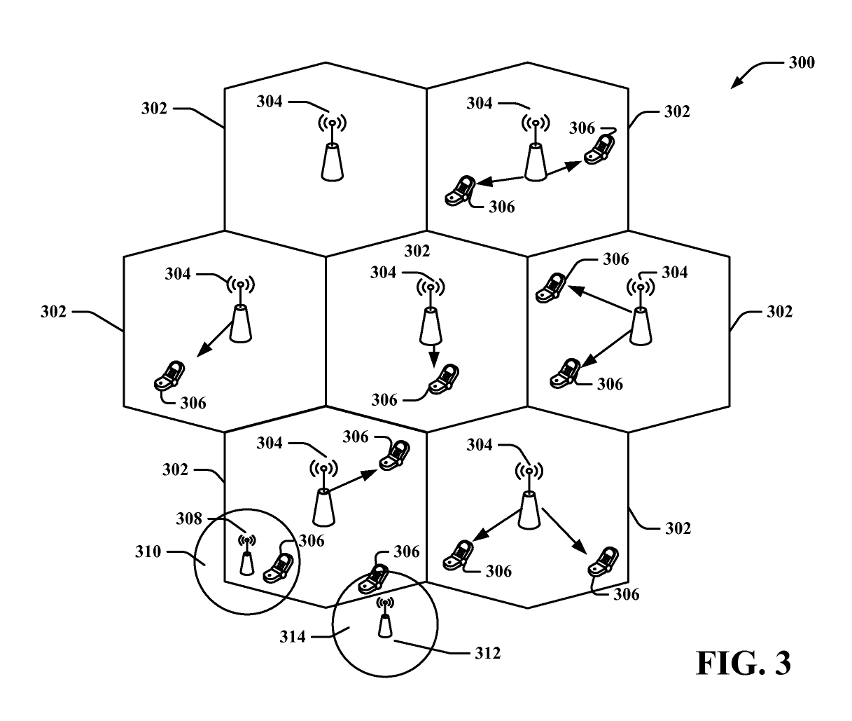

FIG. 3 is a diagram illustrating an example of an access network in an LTE network architecture. In this example, the access network 300 is divided into a number of cellular regions (cells) 302. One or more lower power class eNBs 308, 312 may have cellular regions 310, 314, respectively, that overlap with one or more of the cells 302. The lower power class eNBs 308, 312 may be femto cells (e.g., home eNBs (HeNBs)), pico cells, or micro cells. A higher power class or macro eNB 304 is assigned to a cell 302 and is configured to provide an access point to the EPC 210 for all the UEs 306 in the cell 302. There is no centralized controller in this example of an access network 300, but a centralized controller may be used in alternative configurations. The eNB 304 is responsible for all radio related functions including radio bearer control, admission control, mobility control, scheduling, security, and connectivity to the serving gateway 216 (see FIG. 2).

The modulation and multiple access scheme employed by the access network 300 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 304 may have multiple antennas supporting MIMO technology. The use of MIMO technology enables the eNB 304 to exploit the spatial domain to support spatial multiplexing, beamforming, and transmit diversity.

Spatial multiplexing may be used to transmit different streams of data simultaneously on the same frequency. The data steams may be transmitted to a single UE 306 to increase the data rate or to multiple UEs 306 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 306 with different spatial signatures, which enables each of the UE(s) 306 to recover the one or more data streams destined for that UE 306. On the uplink, each UE 306 transmits a spatially precoded data stream, which enables the eNB 304 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PARR).

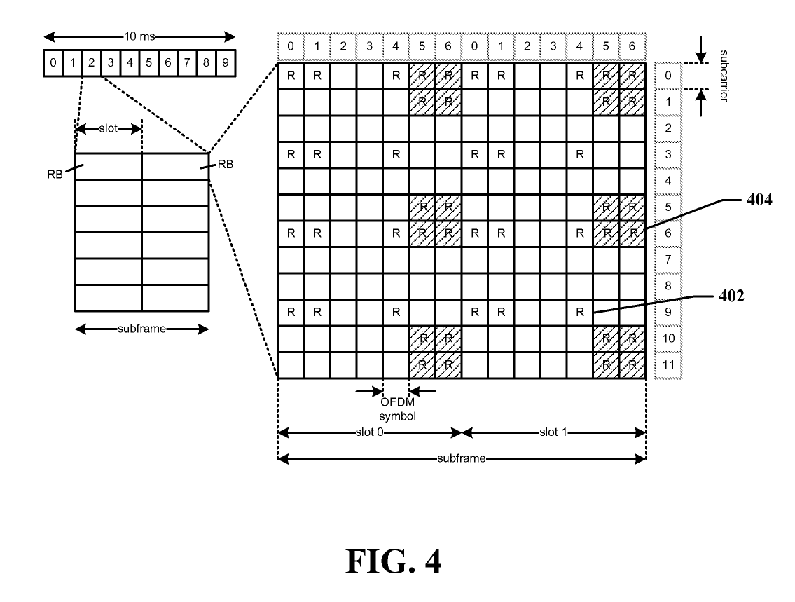

Various frame structures may be used to support the DL and UL transmissions. An example of a DL frame structure will now be presented with reference to FIG. 4. However, as those skilled in the art will readily appreciate, the frame structure for any particular application may be different depending on any number of factors. In this example, a frame (10 ms) is divided into 10 equally sized sub-frames. Each sub-frame includes two consecutive time slots.

A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. Some of the resource elements, as indicated as R 402, 404, include DL reference signals (DL-RS). The DL-RS include Cell-specific RS (CRS) (also sometimes called common RS) 402 and UE-specific RS (UE-RS) 404. UE-RS 404 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

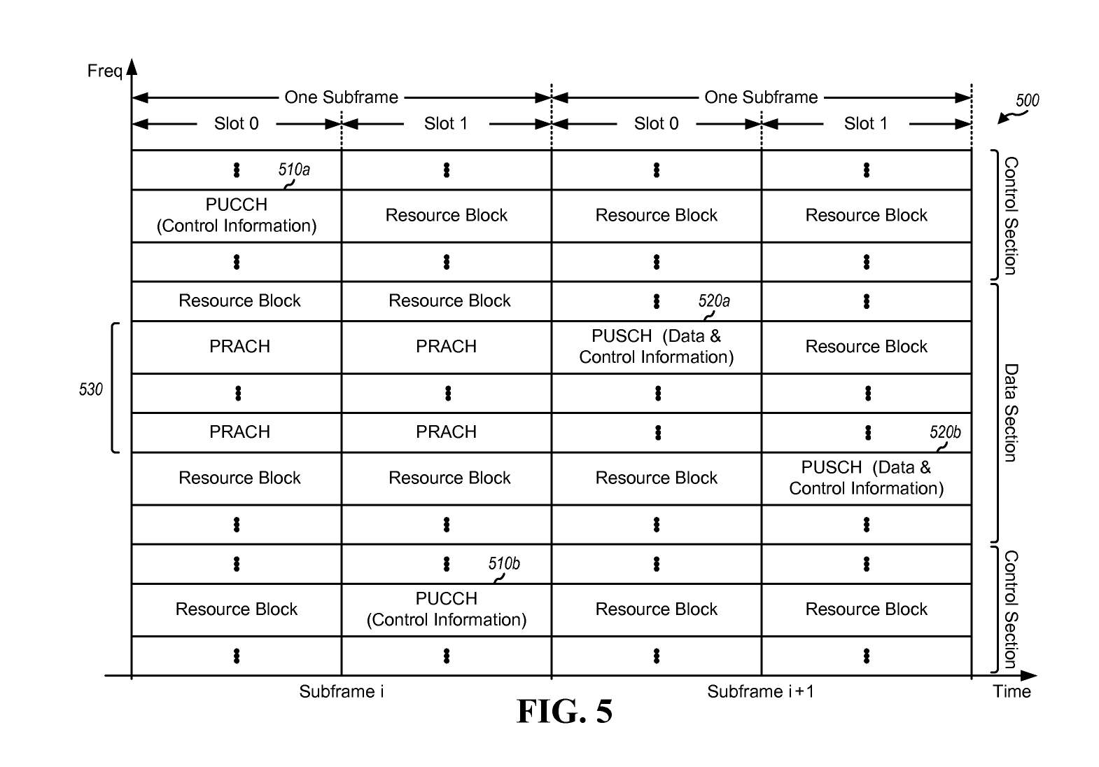

An example of a UL frame structure 500 will now be presented with reference to FIG. 5. FIG. 5 shows an exemplary format for the UL in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 5 results in the data section including contiguous subcarriers, which may allow a single UE to be assigned all of the contiguous subcarriers in the data section.

A UE may be assigned resource blocks 510a, 510b in the control section to transmit control information to an eNB. The UE may also be assigned resource blocks 520a, 520b in the data section to transmit data to the eNB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. A UL transmission may span both slots of a subframe and may hop across frequency as shown in FIG. 5.

As shown in FIG. 5, a set of resource blocks may be used to perform initial system access and achieve UL synchronization in a physical random access channel (PRACH) 530. The PRACH 530 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) and a UE can make only a single PRACH attempt per frame (10 ms).

The PUCCH, PUSCH, and PRACH in LTE are described in 3GPP TS 36.211, entitled “Evolved Universal Terrestrial Radio Access (E-UTRA); Physical Channels and Modulation,” which is publicly available.

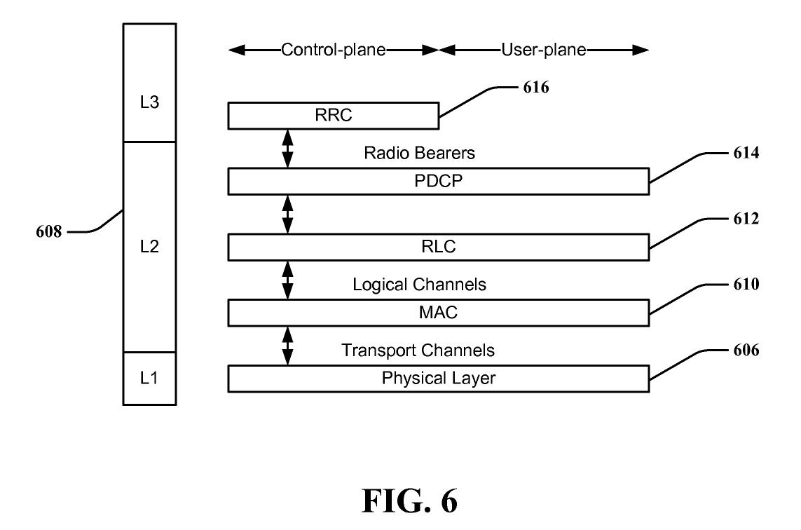

The radio protocol architecture may take on various forms depending on the particular application. An example for an LTE system will now be presented with reference to FIG. 6. FIG. 6 is a conceptual diagram illustrating an example of the radio protocol architecture for the user and control planes.

Turning to FIG. 6, the radio protocol architecture for the UE and the eNB is shown with three layers: Layer 1, Layer 2, and Layer 3. Layer 1 is the lowest layer and implements various physical layer signal processing functions. Layer 1 will be referred to herein as the physical layer 606. Layer 2 (L2 layer) 608 is above the physical layer 606 and is responsible for the link between the UE and eNB over the physical layer 606.

In the user plane, the L2 layer 608 includes a media access control (MAC) sublayer 610, a radio link control (RLC) sublayer 612, and a packet data convergence protocol (PDCP) 614 sublayer, which are terminated at the eNB on the network side. Although not shown, the UE may have several upper layers above the L2 layer 608 including a network layer (e.g., IP layer) that is terminated at the PDN gateway 208 (see FIG. 2) on the network side, and an application layer that is terminated at the other end of the connection (e.g., far end UE, server, etc.).

The PDCP sublayer 614 provides multiplexing between different radio bearers and logical channels. The PDCP sublayer 614 also provides header compression for upper layer data packets to reduce radio transmission overhead, security by ciphering the data packets, and handover support for UEs between eNBs. The RLC sublayer 612 provides segmentation and reassembly of upper layer data packets, retransmission of lost data packets, and reordering of data packets to compensate for out-of-order reception due to hybrid automatic repeat request (HARQ). The MAC sublayer 610 provides multiplexing between logical and transport channels. The MAC sublayer 610 is also responsible for allocating the various radio resources (e.g., resource blocks) in one cell among the UEs. The MAC sublayer 610 is also responsible for HARQ operations.

In the control plane, the radio protocol architecture for the UE and eNB is substantially the same for the physical layer 606 and the L2 layer 608 with the exception that there is no header compression function for the control plane. The control plane also includes a radio resource control (RRC) sublayer 616 in Layer 3. The RRC sublayer 616 is responsible for obtaining radio resources (i.e., radio bearers) and for configuring the lower layers using RRC signaling between the eNB and the UE.

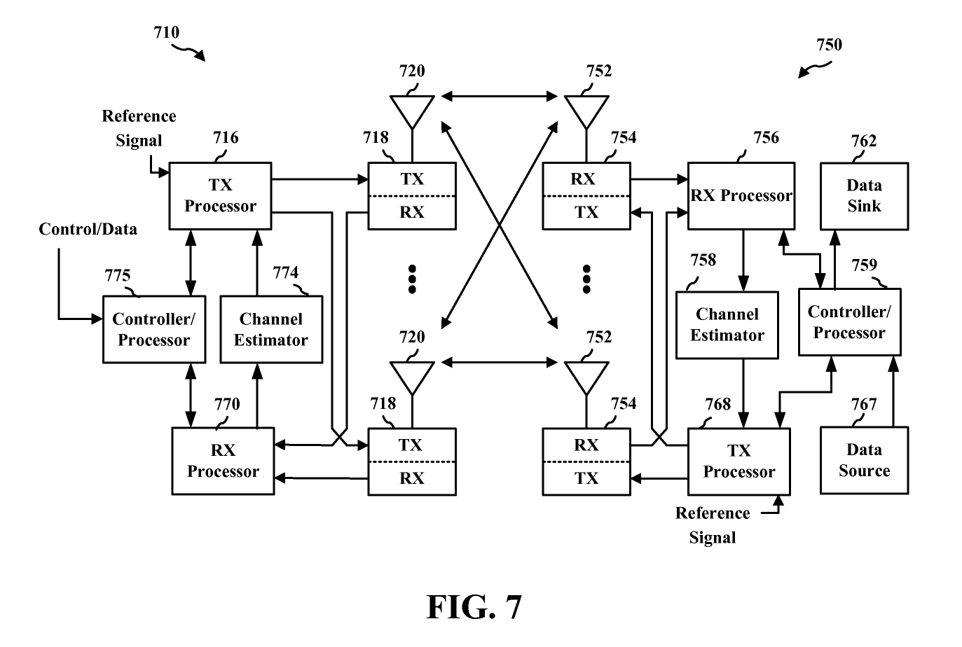

FIG. 7 is a block diagram of an eNB 710 in communication with a UE 750 in an access network. In the DL, upper layer packets from the core network are provided to a controller/processor 775. The controller/processor 775 implements the functionality of the L2 layer described earlier in connection with FIG. 6. In the DL, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter 718TX. Each transmitter 718TX modulates an RF carrier with a respective spatial stream for transmission.

At the UE 750, each receiver 754RX receives a signal through its respective antenna 752. Each receiver 754RX recovers information modulated onto an RF carrier and provides the information to the receiver (RX) processor 756.

The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 710. These soft decisions may be based on channel estimates computed by the channel estimator 758. The soft decisions are then decoded and deinterleaved to recover the data and control signals that were originally transmitted by the eNB 710 on the physical channel. The data and control signals are then provided to the controller/processor 759.

The controller/processor 759 implements the L2 layer described earlier in connection with FIG. 6. In the UL, the control/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the UL, a data source 767 is used to provide upper layer packets to the controller/processor 759. The data source 767 represents all protocol layers above the L2 layer (L2). Similar to the functionality described in connection with the DL transmission by the eNB 710, the controller/processor 759 implements the L2 layer for the user plane and the control plane by providing header compression, ciphering, packet segmentation and reordering, and multiplexing between logical and transport channels based on radio resource allocations by the eNB 710. The controller/processor 759 is also responsible for HARQ operations, retransmission of lost packets, and signaling to the eNB 710.

Channel estimates derived by a channel estimator 758 from a reference signal or feedback transmitted by the eNB 710 may be used by the TX processor 768 to select the appropriate coding and modulation schemes, and to facilitate spatial processing. The spatial streams generated by the TX processor 768 are provided to different antenna 752 via separate transmitters 754TX. Each transmitter 754TX modulates an RF carrier with a respective spatial stream for transmission.

The UL transmission is processed at the eNB 710 in a manner similar to that described in connection with the receiver function at the UE 750. Each receiver 718RX receives a signal through its respective antenna 720. Each receiver 718RX recovers information modulated onto an RF carrier and provides the information to a RX processor 770. The RX processor 770 implements the L1 layer.

The controller/processor 759 implements the L2 layer described earlier in connection with FIG. 6. In the UL, the control/processor 759 provides demultiplexing between transport and logical channels, packet reassembly, deciphering, header decompression, control signal processing to recover upper layer packets from the UE 750. Upper layer packets from the controller/processor 775 may be provided to the core network. The controller/processor 759 is also responsible for error detection using an ACK and/or NACK protocol to support HARQ operations.

In some aspects of the disclosure, the processing system 114 described in relation to FIG. 1 includes the eNB 710. In particular, the processing system 114 may include the TX processor 716, the RX processor 770, and the controller/processor 775. In some aspects of the disclosure, the processing system 114 described in relation to FIG. 1 includes the UE 750. In particular, the processing system 114 may include the TX processor 768, the RX processor 756, and the controller/processor 759.

Control messages provided on a control channel, e.g., the physical downlink control channel (PDCCH) may be utilized to support the transmission of downlink and uplink shared channels, e.g., a physical downlink shared channel (PDSCH) and/or a physical uplink shared channel (PUSCH). For example, the control messages may be utilized to configure the UE to successfully receive, demodulate, and decode the PDSCH. The PDCCH is typically mapped onto resource elements in up to the first three OFDM symbols in the first slot of a subframe, and may indicate a channel resource allocation for UEs.

The control message carried on the PDCCH may include an identifier to identify a particular UE to which the control message is directed. For example, a unicast control message may utilize a cell radio network temporary identifier (C-RNTI) corresponding to a particular UE to mask or scramble a cyclic redundancy check (CRC) included in the PDCCH. In this manner, that particular UE may descramble the CRC and decode the control message, while another UE, having a different C-RNTI, would fail to correctly descramble the CRC and decode the control message.

However, when a network serves a large number of UEs, or a number of high-volume UEs with low-rate, bursty traffic, the E-UTRAN may find it problematic to provide the frequent scheduling required, which often is directed only to small PDSCH or PUSCH assignments. That is, due to the limited capacity of the PDCCH (i.e., limited in terms of power and the frequency/time resource dimensions), the PDCCH may become a bottleneck. For example, a situation may arise wherein the capacity of the PDCCH may be insufficient to prevent a backup in resource allocation due to a burst of traffic to or from UEs in a short time.

By utilizing various aspects of the present disclosure, the bottleneck at the PDCCH may be reduced.

In one aspect of the disclosure, the limited frequency/time resource dimensions available in the PDCCH may be addressed by utilizing a groupcast PDCCH rather than a unicast PDCCH. For example, rather than scrambling the CRC with a UE-specific C-RNTI, the CRC may be scrambled with a group C-RNTI (i.e., a G-RNTI).

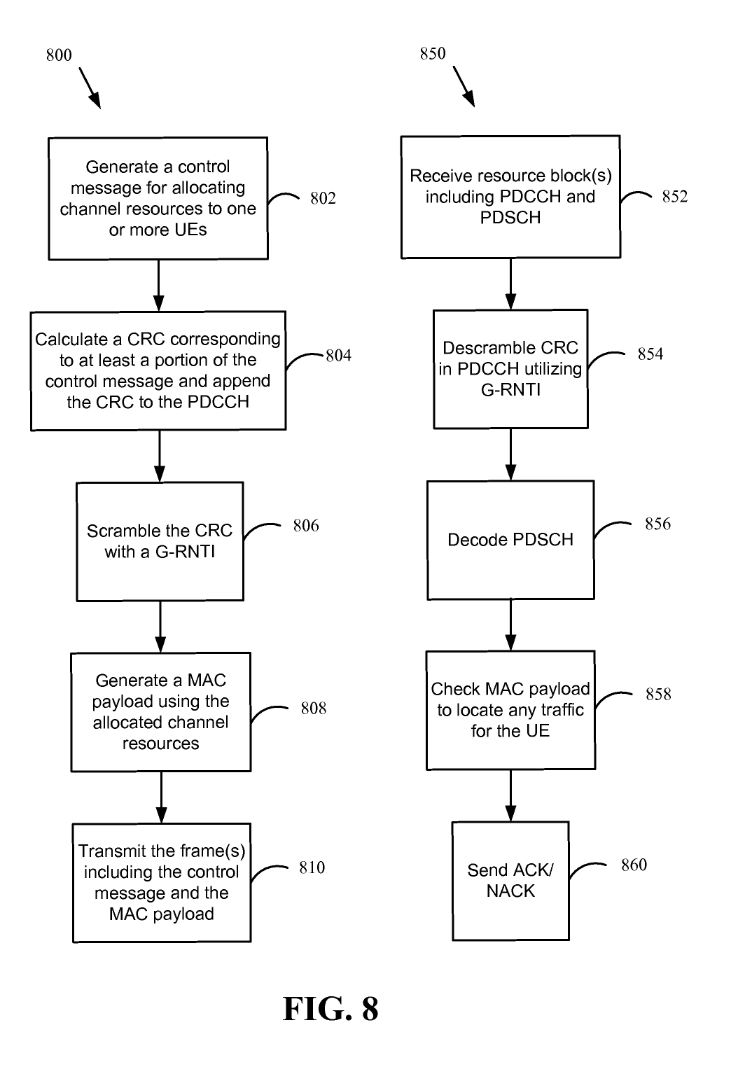

FIG. 8 includes flow charts illustrating a process for allocating channel resources to one or more UEs in accordance with an aspect of the disclosure. Here, process 800 illustrates a process that might be implemented at an eNB, and process 850 illustrates a process that might be implemented at a UE. In block 802, the process generates a control message that includes information relating to channel resources for a group of one or more UEs. As described below, the control message may include information on the PDCCH, or on the PDCCH and the PDSCH.

In block 804, the process calculates a set of CRC parity bits corresponding to at least a portion of the control message. For example, the CRC may be calculated in accordance with the payload of the PDCCH, and appended to the PDCCH.

To identify which group the control message is directed to, in block 806, the process scrambles at least a portion of the control message with a group identifier such as the G-RNTI. In this way, a UE that is a member of the group corresponding to the group identifier may be capable of applying the group identifier to descramble the portion of the control message. In one example, the portion of the control message may be the CRC calculated in block 804.

In some aspects of the disclosure, a UE may be a member of one group, or a plurality of groups corresponding to a plurality of group identifiers. Here, if any one of the group identifiers corresponding to one of the groups of which the UE is a member is utilized to scramble the portion of the control message, the UE may be capable of checking each of its group identifiers, to descramble the control message.

The grouping of UEs into groups may be coordinated by the eNB, or by any other node in the E-UTRAN. The selection of UEs for a particular group may be based on factors such as channel conditions, traffic characteristics, or any other suitable characteristic that may assist in the scheduling of channel resources.

In block 808, the process generates a packet including data for one or more UEs in the group identified by the group identifier. Here, if a particular UE successfully decodes the CRC by utilizing the correct group identifier, it may be taken as an indication that channel resources are allocated to at least one UE in the group of which the UE is a member. In accordance with an aspect of the disclosure, the packet including the data for the one or more UEs corresponding to the group may be a MAC packet provided on a shared channel such as the PDSCH. Here, the packet on the PDSCH may include data for that particular UE. The packet may identify UEs within the PDSCH by their UE-specific identifiers, such as their C-RNTI.

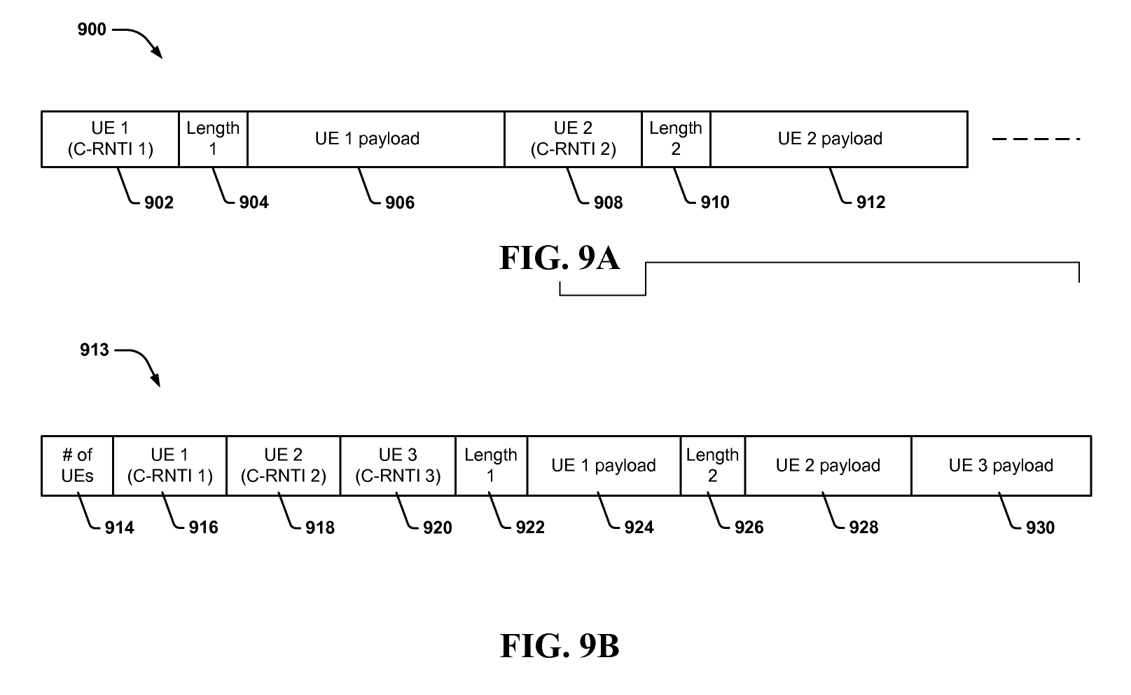

FIG. 9A is a map illustrating a MAC payload carried on a PDSCH in accordance with one aspect of the disclosure. The MAC payload shown in FIG. 9A illustrates a structure for assignments to two UEs. However, in other embodiments, other numbers of UEs can be assigned by extending the payload structure in the format shown in FIG. 9A.

The MAC payload 900 can include C-RNTI portions 902 and 908, which can include RNTI information for two UEs. The MAC payload 900 can also include length portions 904 and 910, which can include information indicative of a length of the UE payload size. The MAC payload 900 can also include payload portions 906 and 912 which can include data for the UEs to which an assignment is provided.

FIG. 9B is a map illustrating a MAC payload in accordance with another aspect of the present disclosure. The MAC payload 913 shown in FIG. 9B illustrates a structure for assignments to three UEs. However, in other embodiments, other numbers of UEs can be assigned by extending the payload structure in the format shown in FIG. 9B.

The MAC payload 913 can include C-RNTI portions 916, 918, and 920, which can include RNTI information for three UEs. The MAC payload 913 can include a first portion 914 including information to indicate the number of UEs to be assigned. The MAC payload 913 can also include length portions 920 and 926, which can include information indicative of a length of a corresponding UE payload size. The MAC payload 913 can also include payload portions 924, 928, and 930, which can include data for the UEs to which an assignment is provided.

In various aspects of the present disclosure, the MAC payloads 900 and 913 can have various structures. In some embodiments, the MAC payloads 900 and 913 include identifying information indicative of the UEs that are being scheduled and/or lengths of the payload sizes for the UEs being scheduled. If only one UE is being scheduled, identifying information need not be included in some embodiments.

As shown in FIGS. 9A and 9B, for N UEs, N−1 length fields can be specified. In these embodiments, the last length can be impliedly derived from the N−1 length fields specified and the PHY transport block size.

Thus, returning to FIG. 8, in block 810, the control message, e.g., carried on the PDCCH, and the MAC packet, e.g., carried on the PDSCH, are transmitted by the eNB. Of course, the PDCCH including the control message and the PDSCH including the MAC packet need not necessarily be transmitted on the same resource block. That is, in some embodiments they may be provided on the same resource block and in other embodiments they may be provided on different resource blocks.

Process 850 illustrates a process that might be implemented at a UE in accordance with an aspect of the disclosure. Here, in block 852, the UE receives one or more resource blocks including a PDCCH and PDSCH as described above. In block 854, the UE descrambles the CRC utilizing a G-RNTI corresponding to a group to which the UE is a member. If successful, then in block 856, the UE decodes the PDSCH, and in block 858, checks a MAC packet in the PDSCH to locate a payload in the MAC packet for that UE. For example, the UE may search the MAC packet for a UE-specific identifier such as a C-RNTI. In block 860, if a C-RNTI and corresponding payload for that UE is found, the UE may send an acknowledgment signal (ACK); and if traffic for that UE is not found in the MAC packet, the UE may send a non-acknowledgment signal (NACK).

The sending of the ACK/NACK indication may be accomplished in various ways in accordance with the present disclosure. In one aspect, on-off keying may be utilized. For example, if the UE fails to locate its C-RNTI in the MAC packet, the UE may send a NACK signal; otherwise, if the UE locates its C-RNTI and a corresponding payload in the MAC packet, the UE may indicate an acknowledgment (ACK) by implementing discontinuous transmission (DTX): i.e., by transmitting no symbol. In this manner, if any UE fails to decode a multi-user PDSCH, the eNB may determine to re-transmit the PDSCH in accordance with one or more received NACK transmissions.

In another aspect, the ACK/NACK indication may be accomplished by assigning, dynamically or semi-statically, multiple PUCCH resources for carrying ACK/NACK symbols, and a conventional ACK/NACK mechanism (e.g., in accordance with 3GPP LTE Rel. 8 specifications) may be utilized.

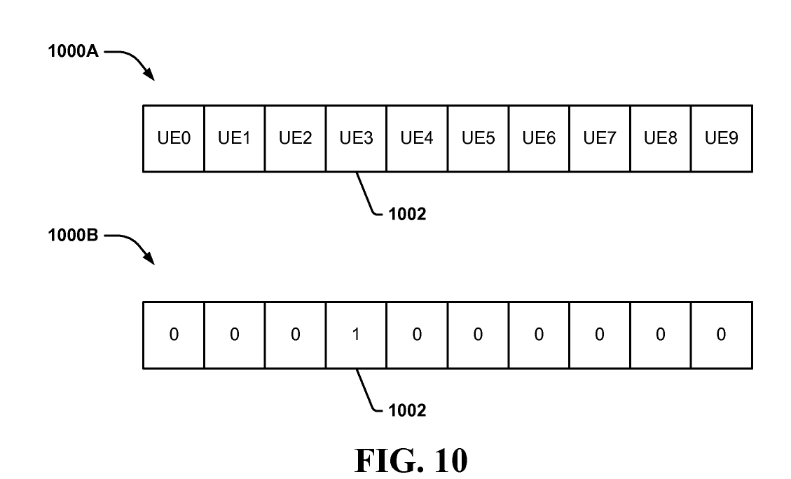

In a further aspect of the disclosure, the control message may include a bitmap for informing a UE whether it is being scheduled. For example, FIG. 10 illustrates a simplified exemplary bitmap 1000 in accordance with this aspect of the disclosure. Here, a particular UE, e.g., UE3, may be informed of one or more bits 1002 within the bitmap corresponding to that particular UE. In this manner, the UE may look to that particular one or more bits 1002, to determine whether the UE is being scheduled by this PDCCH.

Here, the determination of whether the UE is being scheduled may be made in accordance with one or more of the bit location(s) in the bitmap, and the bit value(s). If the UE determines that it is being scheduled, the derivation of the resource allocation for a particular UE may be made as above, i.e., utilizing an identification of each scheduled UE in the MAC payload, or in another aspect of the disclosure, it may further utilize the information in the bitmap to determine the resource allocation.

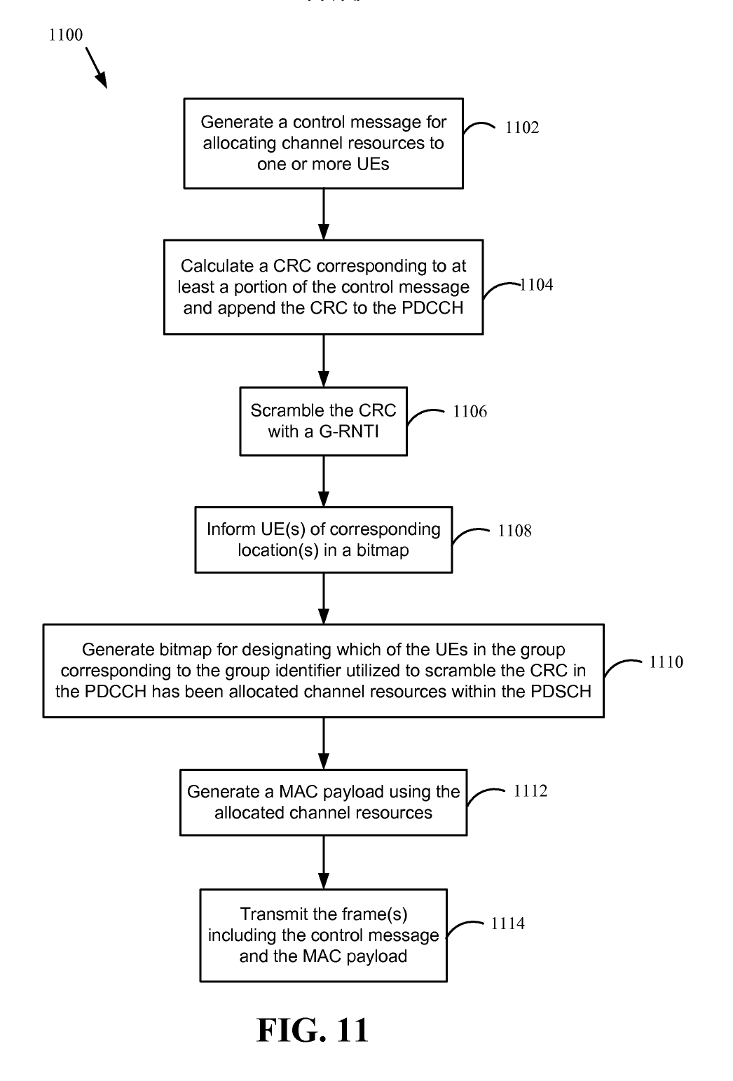

FIG. 11 includes a flow chart illustrating a process 1100 for allocating channel resources to one or more UEs in accordance with an aspect of the disclosure that might be implemented by an eNB. Here, in blocks 1102, 1104, and 1106, the eNB may assign and implement a group assignment in much the same fashion as the process 800 illustrated in FIG. 8. However, in block 1108, the eNB may inform one or more UEs (e.g., utilizing higher-layer signaling) of one or more locations in a bitmap assigned to the respective UE. In block 1110, the process may generate the bitmap for designating which of the UEs in the group corresponding to the group identifier utilized to scramble the CRC in the PDCCH has been allocated channel resources within the PDSCH. In block 1112, the process generates the MAC payload utilizing the allocated channel resources, and in block 1114, the process transmits the one or more frame(s) including the control message and the MAC payload.

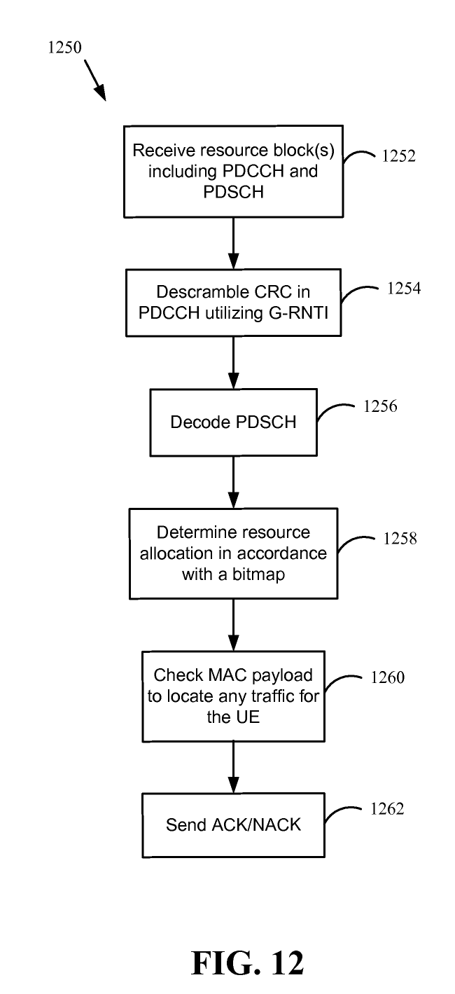

FIG. 12 includes a flow chart illustrating a process 1250 for allocating channel resources to one or more UEs in accordance with an aspect of the disclosure that might be implemented by a UE. Here, in blocks 1252, 1254, and 1256, the UE may receive the PDCCH, descramble its CRC utilizing a G-RNTI corresponding to a group of which the UE is a member, and decode the PDCCH in much the same fashion as the process 850 illustrated in FIG. 8. However, in block 1258, the UE may determine a resource allocation in accordance with a bitmap in the control message payload. If the UE is scheduled as indicated in the bitmap, then in blocks 1260 and 1262, the UE may decode the MAC payload in the PDSCH and send a corresponding ACK/NACK in accordance with a success or failure of decoding the packet therein. However, if the UE is not scheduled as indicated in the bitmap, the UE may not attempt to decode the corresponding PDSCH, and hence, no ACK/NACK transmission may be provided.

Determination of the resource allocation in block 1258 may be made various ways in accordance with the present disclosure. In one aspect the resource allocation may be determined as illustrated in FIG. 10, wherein one or more bit(s) are utilized as an indicator that resources are allocated to a particular UE configured to look at that one or more bit(s). Here, if the UE is not scheduled as indicated in the bitmap, the UE may not attempt to decode the corresponding PDSCH, and hence, no ACK/NACK transmission may be provided.

In another aspect of the disclosure, the determination of the resource allocation in block 1258 may be made as follows. That is, if the total resource allocation size in the PDCCH is denoted as M, and the total number of UEs being scheduled in the PDCCH is denoted as N, then each UE being scheduled in the PDCCH may have a resource allocation size of M/N. In this way, the resource allocation to a particular UE in the PDCCH may be utilized to indicate a location within one or more PDSCHs for a MAC payload. In addition, the resource allocation size may be determined sequentially from the corresponding bitmap location.

In a still further aspect of the disclosure, the resource allocation provided in the PDCCH may correspond to uplink resources to be utilized by the UE, e.g., on a PUSCH. That is, a nested assignment structure for allocating resources on the PUSCH may be utilized. Here, the resource allocation may employ one PDCCH for one or more PUSCHs. Because each UE may have its own starting physical resource block for PUSCH transmission, the ACK/NAK design for the Physical HARQ Indicator Channel (PHICH) can be individually signaled by the eNB.

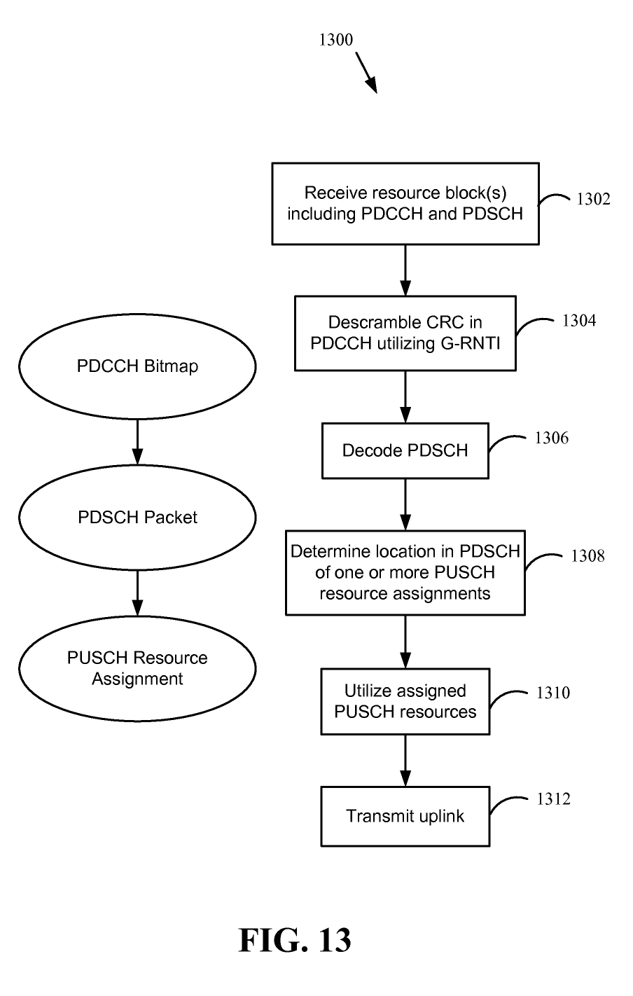

FIG. 13 illustrates a process for a nested assignment of uplink channel resources in accordance with an aspect of the disclosure. Here, in blocks 1302, 1304, and 1306, the UE may receive the PDCCH, descramble its CRC utilizing a G-RNTI corresponding to a group of which the UE is a member, and decode the PDCCH in much the same fashion as the process 850 illustrated in FIG. 8. However, in block 1308, the UE may look, e.g., to a bitmap in the PDCCH, to determine a location in a corresponding PDSCH of one or more PUSCH resource assignments. That is, the channel resource allocation for the PUSCH is located in the PDSCH, and the location in the PDSCH where the PUSCH resource allocation is placed is pointed to by the bitmap in the PDCCH. In block 1310, the UE may utilize the PUSCH resources for information to be transmitted on the uplink, and in block 1312, the UE may transmit the PUSCH on the uplink.

In another aspect of the disclosure, the limited power available in the PDCCH may be addressed by utilizing a relay PDCCH (R-PDCCH) for a control message respecting an allocation of channel resources. The R-PDCCH is included in existing 3GPP standards, designated to carry control information to relays, e.g., for configuration of a backhaul link between the relay and an eNB. As specified, the R-PDCCH utilizes the data region to carry the control signaling.

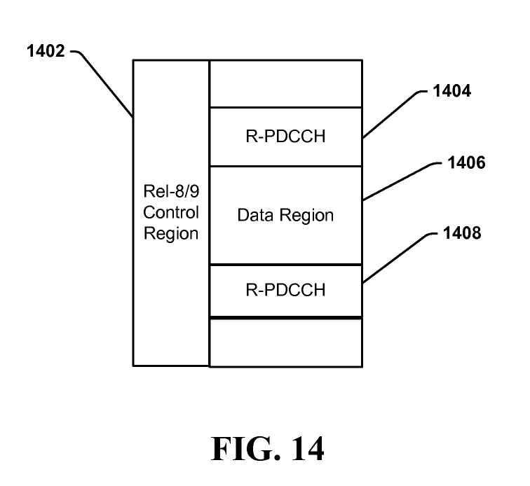

The R-PDCCH may be apportioned into the data region 1306 of a resource block in a FDM, TDM, or a combination of an FDM and TDM fashion. FIG. 14 is an illustration of a particular implementation wherein the R-PDCCH 1404 is apportioned in an FDM fashion. Further, the particular organization of the R-PDCCH 1404 may be semi-statically or dynamically configured. Here, dynamic configuration of the R-PDCCH may be, for example, dictated in the Rel-8 control region 1402. For example, some of the PHICH, PCFICH, and/or the PDCCH resources or fields may be utilized to dynamically configure the R-PDCCH. Still further, the R-PDCCH 1404 may be fully localized at one location in the data region 1406, or, as in the example illustrated in FIG. 14, the R-PDCCH 1404 may be distributed about the data region 1406.

In accordance with an aspect of the present disclosure, a UE may be enabled to receive the R-PDCCH such that the PDCCH may be augmented with the R-PDCCH. Here, the size of the R-PDCCH utilized to augment the PDCCH may be configured according to the demand for the scheduling of channel resources. Thus, if the PDCCH is fully utilized for the scheduling of channel resources, additional space in the R-PDCCH may be allocated and utilized. Further, the space in the R-PDCCH may be utilized to augment or replace the use of the PDSCH as described above. That is, the channel resource allocation may include the PDCCH, the R-PDCCH, or a combination of the two.

Utilization of the R-PDCCH may provide for frequency reuse gain. For example, a portion 1404 of the frequency band may be dedicated to some users, while another portion 1408 of the frequency band may be dedicated to other users with different channel conditions or other circumstances making a suitable selection of the portion of the frequency band appropriate. Further, by selecting suitable frequencies for the R-PDCCH, inter-cell interference coordination is possible. Thus, the control message carried on the R-PDCCH may be better protected than one carried on the PDCCH.

In an aspect of the present disclosure, the PDCCH may be utilized for control messages directed to legacy UEs configured in accordance with 3GPP LTE Rel-8 or 9, while the R-PDCCH may be utilized for control messages directed to UEs configured in accordance with later releases of 3GPP LTE standards.

Of course, those of ordinary skill in the art will comprehend that other aspects of the present disclosure described above, utilizing a group identifier to direct the UE to information in the PDSCH, may be implemented utilizing the R-PDCCH as described here. For example, referring to FIGS. 8, 10, 11, 12, and 13, the control message utilized in any of the described embodiments may be implemented in the R-PDCCH, or in a combination of the PDCCH and the R-PDCCH.

Further, a combination of the above approaches may be utilized. For example, some UEs may utilize the group-based PDCCH resource assignment described above in relation to FIGS. 8-13, while other UEs may utilize a conventional PDCCH for resource allocation or the R-PDCCH for resource allocation as described above.

In an exemplary embodiment, a first group of UEs having good channel conditions may be configured to utilize the group-based PDCCH resource assignment. Here, good channel conditions may correspond to a condition wherein the fraction of required dimensions in the PDCCH is less than the fraction of required power in the PDCCH. Further, a second group of UEs having poor channel conditions may be configured to utilize one of the conventional PDCCH or the R-PDCCH for resource allocation. Here, poor channel conditions may correspond to a condition wherein the fraction of required dimensions in the PDCCH is greater than the fraction of required power in the PDCCH.

Referring to FIG. 1 and FIG. 7, in one configuration, the apparatus 100 for wireless communication includes means for generating a control message; means for generating a packet; means for transmitting the control message on a control channel and the packet on the shared channel; means for scrambling at least a portion of the control message with a group identifier; means for generating a plurality of control messages; means for apportioning the control message to a first region of a resource block; and means for apportioning at least one control message to a second region of the resource block. In some aspects of the disclosure, the aforementioned means includes the processing system 114 configured to perform the functions recited by the aforementioned means. As described supra, the processing system 114 includes the TX Processor 716, the RX Processor 770, and the controller/processor 775. As such, in one configuration, the aforementioned means may be the TX Processor 716, the RX Processor 770, and the controller/processor 775 configured to perform the functions recited by the aforementioned means. Further, in some aspects of the disclosure, the aforementioned means includes the transmitter(s)/receiver(s) 718 configured to perform the functions recited by the aforementioned means.

In another configuration, the apparatus 100 for wireless communication includes means for receiving a control message; means for decoding the control message; means for descrambling at least a portion of the control message with a group identifier; means for receiving a packet on the shared channel; means for seeking for a unique identifier in the packet; means for transmitting a non-acknowledgment signal; means for receiving a packet on the shared channel; means for locating a unique identifier in the packet; means for recovering a payload associated with the unique identifier; means for determining an allocation of channel resources on the shared channel in accordance with one or more bits of a bitmap; means for recovering a payload from the packet; means for utilizing the scheduling information to recover the payload from the packet; means for using the length indicator to recover the payload from the packet; and means for transmitting an uplink packet. In some aspects of the disclosure, the aforementioned means includes the processing system 114 configured to perform the functions recited by the aforementioned means. As described supra, the processing system 114 includes the TX Processor 768, the RX Processor 756, and the controller/processor 759. As such, in one configuration, the aforementioned means may be the TX Processor 768, the RX Processor 756, and the controller/processor 759 configured to perform the functions recited by the aforementioned means. Further, in some aspects of the disclosure, the aforementioned means includes the transmitter(s)/receiver(s) 754 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
generating a control message for indicating an allocation of channel resources to a plurality of access terminals on a shared channel;
generating a packet, comprising: a unique identifier for identifying a first access terminal of the plurality of access terminals, and a payload for the first access terminal; and
transmitting the control message on a control channel and the packet on the shared channel.

2. The method of claim 1, further comprising scrambling at least a portion of the control message with a group identifier, to address the control message to a group of access terminals, the group comprising the plurality of access terminals.

3. The method of claim 1, wherein the control message further comprises an error detection code, and wherein said at least a portion of the control message scrambled by the group identifier comprises the error detection code.

4. The method of claim 3, wherein the error detection code comprises a cyclic redundancy check.

5. The method of claim 1, wherein the packet further comprises a length indicator associated with the payload for the first access terminal corresponding to the unique identifier.

6. The method of claim 1, wherein the control message comprises a bitmap comprising one or more bits corresponding to the first access terminal, for indicating that the first access terminal has been allocated channel resources on the shared channel.

7. The method of claim 1, wherein the packet transmitted on the shared channel comprises information for indicating an allocation of channel resources for the first access terminal to utilize on an uplink transmission.

8. The method of claim 7, wherein the packet transmitted on the shared channel further comprises information for indicating an allocation of channel resources for one or more access terminals in addition to the first access terminal to utilize on respective uplink transmissions.

9. The method of claim 1, wherein the control channel comprises at least a portion of a data region of a resource block.

10. The method of claim 9, wherein the control channel comprises a relay control channel.

11. The method of claim 1, further comprising:
generating a plurality of control messages including the control message;
apportioning the control message to a first region of a resource block; and
apportioning at least one control message of the plurality of control messages to a second region of the resource block.

12. The method of claim 11, wherein the first region and the second region are separated in time.

13. A method of wireless communication, comprising:
receiving a control message for indicating an allocation of channel resources to a plurality of access terminals on a shared channel, wherein at least a portion of the control message is scrambled with a group identifier for addressing the control message to a group of access terminals, the group comprising the plurality of access terminals; and
decoding the control message to recover the allocation of channel resources.

14. The method of claim 13, further comprising decoding the control message by descrambling said at least a portion of the control message with the group identifier.

15. The method of claim 14, wherein the decoding of the control message comprises descrambling said at least a portion of the control message with the group identifier from a plurality of available group identifiers.

16. The method of claim 14, wherein the control message further comprises an error detection code, and wherein said at least a portion of the control message scrambled by the group identifier comprises the error detection code.

17. The method of claim 16, wherein the error detection code comprises a cyclic redundancy check.

18. The method of claim 14, further comprising:
receiving a packet on the shared channel;
seeking for a unique identifier in the packet, for identifying a first access terminal of the plurality of access terminals; and
transmitting a non-acknowledgment signal indicating an absence of the unique identifier in the packet.

19. The method of claim 14, further comprising:
receiving a packet on the shared channel;
locating a unique identifier in the packet, for identifying a first access terminal of the plurality of access terminals; and
recovering a payload associated with the unique identifier.

20. The method of claim 19, wherein the packet further comprises a length indicator, and wherein the payload is recovered using the length indicator.

21. The method of claim 14, wherein the control message comprises a bitmap comprising one or more bits corresponding to the first access terminal, for indicating that the access terminal has been allocated channel resources on the shared channel.

22. The method of claim 21, further comprising:
receiving a packet on the shared channel;
determining an allocation of channel resources on the shared channel in accordance with the one or more bits; and
recovering a payload from the packet using the determined allocation of channel resources.

23. The method of claim 22, wherein the bitmap comprises scheduling information, and wherein the method further comprises utilizing the scheduling information to recover the payload from the packet.

24. The method of claim 23, wherein the bitmap comprises a length indicator associated with a scheduled transmission of the packet, and wherein the method is further configured to use the length indicator to recover the payload from the packet.

25. The method of claim 22, wherein the payload comprises information for indicating an allocation of channel resources for utilization on an uplink transmission.

26. The method of claim 25, further comprising:
transmitting an uplink packet utilizing the allocated channel resources.

27. The method of claim 14, wherein the control message is received on a control channel.

28. The method of claim 27, wherein the control channel comprises at least a portion of a data region of a resource block.

29. The method of claim 28, wherein the control channel comprises a relay control channel.

30. An apparatus for wireless communication, comprising:
means for generating a control message for indicating an allocation of channel resources to a plurality of access terminals on a shared channel;
means for generating a packet, comprising: a unique identifier for identifying a first access terminal of the plurality of access terminals, and a payload for the first access terminal; and
means for transmitting the control message on a control channel and the packet on the shared channel.

31. The apparatus of claim 30, further comprising means for scrambling at least a portion of the control message with a group identifier, to address the control message to a group of access terminals, the group comprising the plurality of access terminals.

32. The apparatus of claim 30, wherein the control message further comprises an error detection code, and wherein said at least a portion of the control message scrambled by the group identifier comprises the error detection code.

33. The apparatus of claim 32, wherein the error detection code comprises a cyclic redundancy check.

34. The apparatus of claim 30, wherein the packet further comprises a length indicator associated with the payload for the first access terminal corresponding to the unique identifier.

35. The apparatus of claim 30, wherein the control message comprises a bitmap comprising one or more bits corresponding to the first access terminal, for indicating that the first access terminal has been allocated channel resources on the shared channel.

36. The apparatus of claim 30, wherein the packet transmitted on the shared channel comprises information for indicating an allocation of channel resources for the first access terminal to utilize on an uplink transmission.

37. The apparatus of claim 36, wherein the packet transmitted on the shared channel further comprises information for indicating an allocation of channel resources for one or more access terminals in addition to the first access terminal to utilize on respective uplink transmissions.

38. The apparatus of claim 30, wherein the control channel comprises at least a portion of a data region of a resource block.

39. The apparatus of claim 38, wherein the control channel comprises a relay control channel.

40. The apparatus of claim 30, further comprising:
means for generating a plurality of control messages including the control message;
means for apportioning the control message to a first region of a resource block; and
means for apportioning at least one control message of the plurality of control messages to a second region of the resource block.

41. The apparatus of claim 40, wherein the first region and the second region are separated in time.

42. An apparatus for wireless communication, comprising:
means for receiving a control message for indicating an allocation of channel resources to a plurality of access terminals on a shared channel, wherein at least a portion of the control message is scrambled with a group identifier for addressing the control message to a group of access terminals, the group comprising the plurality of access terminals; and
means for decoding the control message to recover the allocation of channel resources.

43. The apparatus of claim 42, further comprising means for decoding the control message by descrambling said at least a portion of the control message with the group identifier.

44. The apparatus of claim 43, wherein the means for decoding the control message comprises means for descrambling said at least a portion of the control message with the group identifier from a plurality of available group identifiers.

45. The apparatus of claim 43, wherein the control message further comprises an error detection code, and wherein said at least a portion of the control message scrambled by the group identifier comprises the error detection code.

46. The apparatus of claim 45, wherein the error detection code comprises a cyclic redundancy check.

47. The apparatus of claim 43, further comprising:
means for receiving a packet on the shared channel;
means for seeking for a unique identifier in the packet, for identifying a first access terminal of the plurality of access terminals; and
means for transmitting a non-acknowledgment signal indicating an absence of the unique identifier in the packet.

48. The apparatus of claim 43, further comprising:
means for receiving a packet on the shared channel;
means for locating a unique identifier in the packet, for identifying a first access terminal of the plurality of access terminals; and
means for recovering a payload associated with the unique identifier.

49. The apparatus of claim 48, wherein the packet further comprises a length indicator, and wherein the payload is recovered using the length indicator.

50. The apparatus of claim 43, wherein the control message comprises a bitmap comprising one or more bits corresponding to the first access terminal, for indicating that the access terminal has been allocated channel resources on the shared channel.

51. The apparatus of claim 50, further comprising:
means for receiving a packet on the shared channel;
means for determining an allocation of channel resources on the shared channel in accordance with the one or more bits; and
means for recovering a payload from the packet using the determined allocation of channel resources.

52. The apparatus of claim 51, wherein the bitmap comprises scheduling information, and wherein the apparatus further comprises means for utilizing the scheduling information to recover the payload from the packet.

53. The apparatus of claim 52, wherein the bitmap comprises a length indicator associated with a scheduled transmission of the packet, and wherein the apparatus further comprises means for using the length indicator to recover the payload from the packet.

54. The apparatus of claim 51, wherein the payload comprises information for indicating an allocation of channel resources for utilization on an uplink transmission.

55. The apparatus of claim 54, further comprising:
means for transmitting an uplink packet utilizing the allocated channel resources.

56. The apparatus of claim 43, wherein the control message is received on a control channel.

57. The apparatus of claim 56, wherein the control channel comprises at least a portion of a data region of a resource block.

58. The apparatus of claim 57, wherein the control channel comprises a relay control channel.

59. A computer program product, comprising:
a computer-readable medium comprising code for:
generating a control message for indicating an allocation of channel resources to a plurality of access terminals on a shared channel;
generating a packet, comprising: a unique identifier for identifying a first access terminal of the plurality of access terminals, and a payload for the first access terminal; and
transmitting the control message on a control channel and the packet on the shared channel.

60. A computer program product, comprising:
a computer-readable medium comprising code for:
receiving a control message for indicating an allocation of channel resources to a plurality of access terminals on a shared channel, wherein at least a portion of the control message is scrambled with a group identifier for addressing the control message to a group of access terminals, the group comprising the plurality of access terminals; and
decoding the control message to recover the allocation of channel resources.

61. An apparatus for wireless communication, comprising:
a processing system configured to:
generate a control message for indicating an allocation of channel resources to a plurality of access terminals on a shared channel;
generate a packet, comprising: a unique identifier for identifying a first access terminal of the plurality of access terminals, and a payload for the first access terminal; and
transmit the control message on a control channel and the packet on the shared channel.

62. The apparatus of claim 61, wherein the processing system is further configured to scramble at least a portion of the control message with a group identifier, to address the control message to a group of access terminals, the group comprising the plurality of access terminals.

63. The apparatus of claim 61, wherein the control message further comprises an error detection code, and wherein said at least a portion of the control message scrambled by the group identifier comprises the error detection code.

64. The apparatus of claim 63, wherein the error detection code comprises a cyclic redundancy check.

65. The apparatus of claim 61, wherein the packet further comprises a length indicator associated with the payload for the first access terminal corresponding to the unique identifier.

66. The apparatus of claim 61, wherein the control message comprises a bitmap comprising one or more bits corresponding to the first access terminal, for indicating that the first access terminal has been allocated channel resources on the shared channel.

67. The apparatus of claim 61, wherein the packet transmitted on the shared channel comprises information for indicating an allocation of channel resources for the first access terminal to utilize on an uplink transmission.

68. The apparatus of claim 67, wherein the packet transmitted on the shared channel further comprises information for indicating an allocation of channel resources for one or more access terminals in addition to the first access terminal to utilize on respective uplink transmissions.

69. The apparatus of claim 61, wherein the control channel comprises at least a portion of a data region of a resource block.

70. The apparatus of claim 69, wherein the control channel comprises a relay control channel.

71. The apparatus of claim 61, wherein the processing system is further configured to:
generate a plurality of control messages including the control message;
apportion the control message to a first region of a resource block; and
apportion at least one control message of the plurality of control messages to a second region of the resource block.

72. The apparatus of claim 71, wherein the first region and the second region are separated in time.

73. An apparatus for wireless communication, comprising:
a processing system configured to:
receive a control message for indicating an allocation of channel resources to a plurality of access terminals on a shared channel, wherein at least a portion of the control message is scrambled with a group identifier for addressing the control message to a group of access terminals, the group comprising the plurality of access terminals; and
decode the control message to recover the allocation of channel resources.

74. The apparatus of claim 73, wherein the processing system is further configured to decode the control message by descrambling said at least a portion of the control message with the group identifier.

75. The apparatus of claim 74, wherein the decoding of the control message comprises descrambling said at least a portion of the control message with the group identifier from a plurality of available group identifiers.

76. The apparatus of claim 74, wherein the control message further comprises an error detection code, and wherein said at least a portion of the control message scrambled by the group identifier comprises the error detection code.

77. The apparatus of claim 76, wherein the error detection code comprises a cyclic redundancy check.

78. The apparatus of claim 74, wherein the processing system is further configured to:
receive a packet on the shared channel;
seek for a unique identifier in the packet, for identifying a first access terminal of the plurality of access terminals; and
transmit a non-acknowledgment signal indicating an absence of the unique identifier in the packet.

79. The apparatus of claim 74, wherein the processing system is further configured to:
receive a packet on the shared channel;
locate a unique identifier in the packet, for identifying a first access terminal of the plurality of access terminals; and
recover a payload associated with the unique identifier.

80. The apparatus of claim 79, wherein the packet further comprises a length indicator, and wherein the payload is recovered using the length indicator.

81. The apparatus of claim 74, wherein the control message comprises a bitmap comprising one or more bits corresponding to the first access terminal, for indicating that the access terminal has been allocated channel resources on the shared channel.

82. The apparatus of claim 81, wherein the processing system is further configured to:
receive a packet on the shared channel;
determine an allocation of channel resources on the shared channel in accordance with the one or more bits; and
recover a payload from the packet using the determined allocation of channel resources.

83. The apparatus of claim 82, wherein the bitmap comprises scheduling information, and wherein the method further comprises utilizing the scheduling information to recover the payload from the packet.

84. The apparatus of claim 83, wherein the bitmap comprises a length indicator associated with a scheduled transmission of the packet, and wherein the method is further configured to use the length indicator to recover the payload from the packet.

85. The apparatus of claim 82, wherein the payload comprises information for indicating an allocation of channel resources for utilization on an uplink transmission.

86. The apparatus of claim 85, wherein the processing system is further configured to:
transmit an uplink packet utilizing the allocated channel resources.

87. The apparatus of claim 74, wherein the control message is received on a control channel.

88. The apparatus of claim 87, wherein the control channel comprises at least a portion of a data region of a resource block.

89. The apparatus of claim 88, wherein the control channel comprises a relay control channel.
